(19) United States
(12) Patent Application Publication
(10) Pub. No.: US 2008/0005497 A1
(43) Pub. Date: Jan. 3, 2008

(54) Systems and Methods for Managing Media Data

(75) Inventors: Bohdan S. Prus, Alpharetta, GA (US); Samuel H. Russ, Lawrenceville, GA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/428,362

(22) Filed: Jun. 30, 2006

(51) Int. Cl. G06F 13/00

(52) U.S. Cl. 711/154

(57) ABSTRACT

Systems and methods for managing media data are disclosed. A system includes a digital media device comprising memory, processing logic, and a communications interface configured to transport data between an external storage device and the digital media device. The external storage device is configured to store media data recorded by the digital media device and maintain a media catalog associated with the media data stored to the external storage device.

### BACKGROUND

1. Technical Field

The present disclosure generally relates to digital media devices, and more specifically, managing data associated with a digital media device.

2. Description of the Related Art

Digital recording devices can be used for recording media signals, such as audio and/or video signals, in a digital format. Such devices may also be used for the storage and playback of such signals. Specific examples of such digital media recording devices are a Digital Video Recorder (DVR) and a Personal Video Recorder (PVR).

In general, a DVR may be used to schedule and record future television programs, for buffering live television programs in a time-shift buffer, and/or playback of the digitally recorded media. The incoming media signals may be received, potentially decrypted and/or encoded, and digitally stored on a storage medium. The storage medium is commonly a non-volatile storage device such as a hard disk drive (HDD) (i.e., hard drive), among other acceptable mediums. Such an HDD can write the digital media data on a magnetic surface of the HDD disk platters and read the media data at later times for playback.

Conventional DVRs include an HDD located inside the housing of the DVR for storing the media data. This HDD may also have catalog information related to the media data stored on the HDD. The catalog information may include information about associated media data, such as guide information (i.e., title, actors, genre, program description, channel, time, etc.), recording date, and/or trick play information. The DVR may include logical rules for determining which of the media data stored to the HDD can be deleted at a particular opportunity, and the rules may use the catalog information for accomplishing this purpose. For example, such rules can be applied to delete shows being older than a predetermined length of time. According to some embodiments, the rules can specify that the associated media data that meets the rules can be deleted at a time when space is needed (e.g., in order to record another instance of media data).

Some DVRs include the capability of attaching an external HDD to the DVR. However, because the external HDD may be connected and/or disconnected from the DVR, special considerations for managing the media data stored to the devices are needed. Accordingly, the present disclosure includes a number of potential embodiments for carrying out media data management in such an environment, among others.

### BRIEF DESCRIPTION OF THE DRAWINGS

The components in the drawings are not necessarily to scale relative to each other. Like reference numerals designate corresponding parts throughout the several views.

FIG. 1 depicts a block diagram of an arrangement of a digital video recorder (DVR) in accordance with some embodiments of the present disclosure.

FIG. 2 depicts a block diagram of selected system components of an exemplary embodiment of the DVR of FIG. 1.

FIG. 3 depicts an embodiment of a data storage configuration that can be used in association with the internal and/or external storage devices of the DVR 102 of FIG. 2.

FIG. 4 depicts another exemplary embodiment of a data storage configuration that can be used in association with the internal and/or external storage of the DVR of FIG. 2.

FIG. 5 is a process flow diagram depicting an exemplary embodiment of a process for applying retention rules to one or more associated storage devices, such as internal storage and and/or external storage of the DVR of FIG. 2.

FIG. 6 depicts a flow diagram of an exemplary embodiment of a process for recording an instance of media data to one or more associated storage devices of the DVR of FIG. 2.

FIG. 7 depicts a flow diagram of an exemplary embodiment of a process for retrieving an instance of media data from one or more associated storage devices of the DVR of FIG. 2.

FIG. 8 depicts a flow diagram of another exemplary embodiment of a process for applying retention rules to one or more associated storage devices of the DVR of FIG. 2.

### DETAILED DESCRIPTION

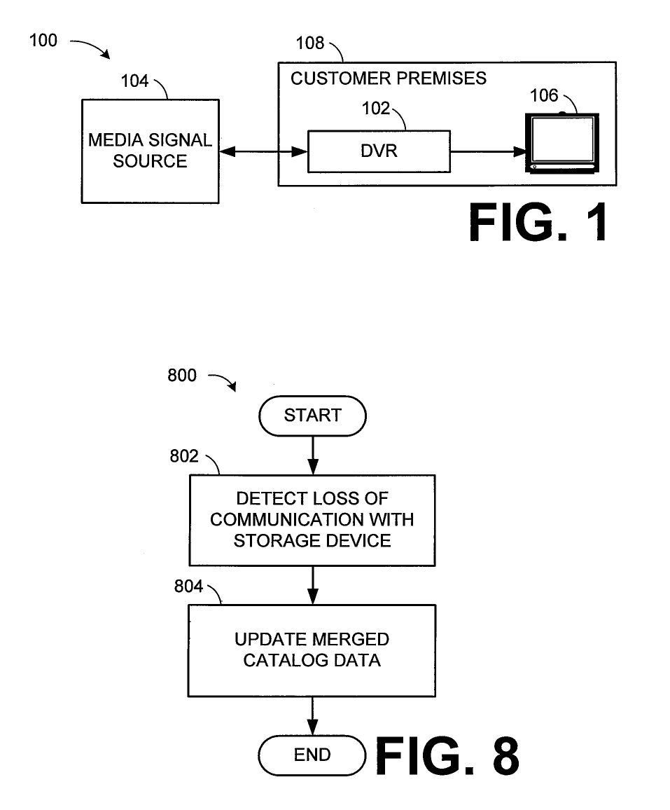

FIG. 1 depicts an embodiment of an arrangement 100 of a digital media recording system in accordance with selected embodiments of the present disclosure, among others. According to some embodiments, the digital media recording system includes a digital video recorder (DVR) 102, configured to record media content, such as, among others, video and/or audio content. In some instances, the digital media recorder is, among other devices, used for recording digital media, and is embodied in a personal video recorder (PVR), a personal digital recorder (PDR), a personal computer, laptop computer, and/or personal digital assistant (PDA), among other electronic devices configured to execute media recording capabilities.

Media content is also referred to herein as media programs or media programming. Some examples of media programming used herein include, but are not intended to be limited to, television programs and radio programs. An instance of media programming or media content could be, for example, a recording of a television show (e.g., an episode of Smallville). A series of media programming could be, for example, a number of episodes of a television show (e.g., the last five recordings of Smallville). The media content is recorded by the digital media recorder as media data. In some instances, such media data is encoded audio and/or video signals, among other representations of the media content that is in a form suitable for processing by DVR 102. Such media signals could be analog and/or digital signals.

According to some embodiments, DVR 102 is also embedded within, or otherwise associated with, other electronic devices such as a cable television set-top box (STB), a tuner, a television, and/or a satellite-television receiver, or a playback device, such as a television, among others. DVR 102 is configured to receive media signals from a media signal source 104, and is also in communication with a playback device, such as television 106. According to some embodiments, the playback device is a computer display, portable device, or audio receiver, among other devices capable of emitting or displaying media.

Media signal source 104 is any of a number of sources of analog and/or digital media signals, such as video and/or audio signals. According to some embodiments, media signal source 104 is, for example, among others, a satellite television source, an over-the-air broadcast source, a cable-television (CATV) system, or a server configured to stream, or otherwise provide, media signals over a network (i.e., LAN., WAN, Internet, etc.).

In some instances, media signal source 104 also transmits additional network data, including Internet traffic, teletext, closed-captioning, and/or programming information, among others. Media signal source 104 transmits such signals to DVR 102, which is located in one implementation, among others, remotely at a customer premises 108. Although only one media signal source is depicted, in some embodiments DVR 102 receives media signals from more than one media signal source. For example, in one such embodiment, DVR 102 receives signals from a CATV system as well as an over-the-air antenna.

Television 106 receives and emits signals from DVR 102 that represent the recorded (and unrecorded) media signals. For example, television 106 emits, among others, recorded audio and/or video signals. According to some embodiments, television 106 also displays any windows associated with a graphical user interface generated by DVR 102.

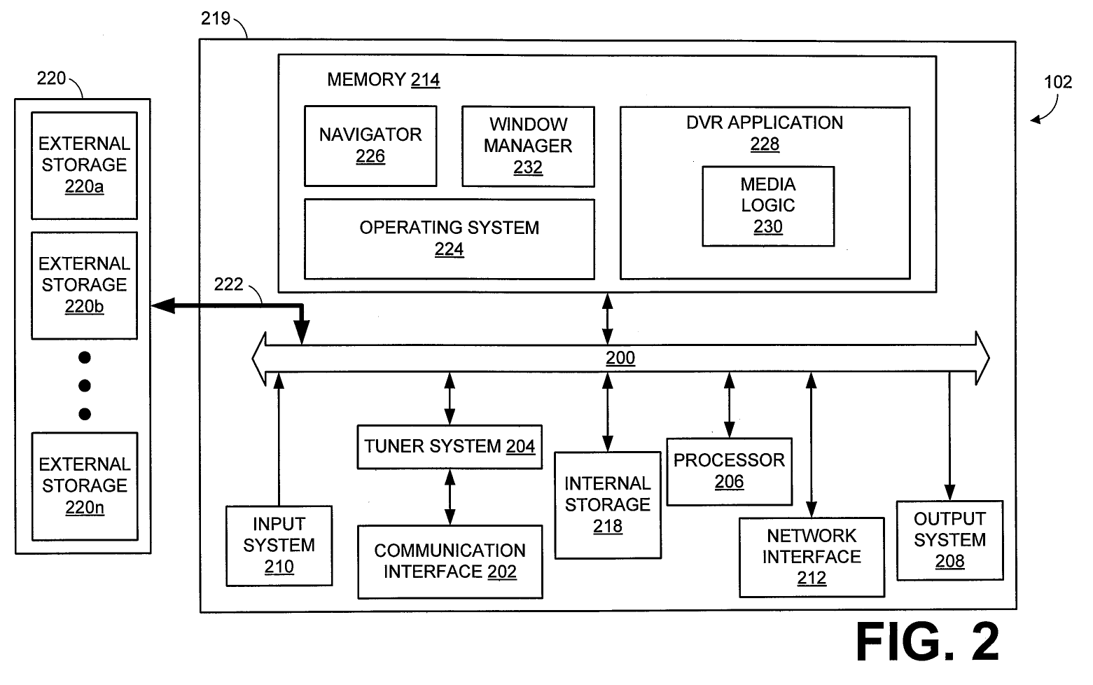

FIG. 2 is a block diagram depicting selected system components of an exemplary embodiment of the DVR 102 of FIG. 1. Omitted from FIG. 2 are a number of conventional components, known to those skilled in the art, that are unnecessary to explain the operation of the disclosed systems and methods for managing media data. FIG. 2 depicts several components commonly communicating through a local bus 200. For example, DVR 102 includes a communications interface 202 for receiving video, audio and other media signals and, potentially, programming information from media signal source 104 (FIG. 1). DVR 102 also includes a tuner system 204 for receiving and selecting one or more selected channels of media signals. For example, according to some instances, tuner system 204 can tune to a particular television channel or stream, and the media signals associated with this channel or stream are recorded by the DVR 102.

DVR 102 further includes at least one processor 206 for controlling the operations of the DVR 102 and an output system 208 for driving a playback device (e.g., television 106). An input system 210 receives user inputs provided via a wired or wireless input device such as, for example, a hand-held remote control, a transmitter with buttons or keys located on the exterior of the DVR, and/or a keyboard, among other potential input devices.

Network interface 212 transmits and/or receives data over a network such as a LAN, WAN, or the Internet. For example, data is transferred to/from another DVR, a media signal source, or a centralized server through network interface 212, among others. The data transmitted includes media signals and/or other data, such as, among other information, programming information, or data capable of being stored and/or displayed to the user, among others. The programming information could include information related to the title, actors, genre, program description, channel, time, etc. of media content available for transmission to the DVR 102. Such information can also be referred to as “guide data” or “catalog data.”

Network interface 212 comprises, for example, an Ethernet interface, an IEEE-1394 interface, a USB (Universal Serial Bus) interface, a serial interface, a parallel interface, a wireless radio frequency (RF) interface, a telephone line interface, a power-line interface, a coaxial cable interface, and/or an infrared (IR) interface, among others.

Memory 214, which can include volatile and/or non-volatile memory, stores one or more programmed software applications, routines, drivers, or other functional elements (herein broadly referred to as applications), which contain instructions that are executed by processor 206 under the direction of operating system 216. Input data used by an application is stored in memory 214 and read by processor 206 as needed during the course of the execution of the application. In some instances, this input data is data stored in memory 214 by a secondary application or other source, either internal or external to DVR 102. In other stances, data is created with the application at the time it was generated as a software application program. According to some embodiments, other logic is stored in memory 212 for operation of the DVR 102.

Internal storage 218 comprises a recordable medium and may be any of a number of devices available for non-volatile data storage, such as, among others, a hard disk drive (HDD), optical drive, or flash memory, for example. Although depicted as separate components, internal storage 218 and memory 214 are the same device in some embodiments. Among other uses, internal storage 218 is used for storing media data, such as encoded media signals received through communication interface 202 and/or network interface 212. In some embodiments, before being stored on the recordable medium, the media content is digitally encoded by the DVR itself or by means external from the DVR, such as the media signal source or a cable set-top box. Media content is stored on the recordable medium in an encrypted or unencrypted state.

Like internal storage 218, external storage 220 also comprises a recordable medium for non-volatile data storage, such as, among others, a hard disk drive (HDD), optical drive, or flash memory, for example. However, unlike internal storage 218, which is located within the DVR enclosure (i.e., housing) 219, external storage 220 can be removably attached to DVR 102 through a communications interface 222. According to some embodiments, external storage 220 is located remotely from the DVR, such as in other rooms or locations within a house.

Although only one external storage device is used in some embodiments, it is contemplated that other embodiments may comprise a plurality of storage devices 220a-220n. In some instances, for example, devices 220a-220n comprise a plurality of HDDs. It can be appreciated that the one or more HDDs can be combined to communicate with DVR 102 over one or more communication interfaces using a hub or other similar device. According to some embodiments, the external storage 220 is provided in a self-supporting, external housing. Some embodiments also include an integrated power supply for powering to the external storage and/or cooling devices, such as fans and/or heat dissipating devices.

According to some embodiments, communication interface 222 can be a high-speed communication bus, such as, among others, a bus operating under the Advanced Technology Attachment (ATA) standard, and more specifically, the Serial-ATA (i.e., SATA) standard version 2.5, which is available from the Serial ATA International Organization and is hereby incorporated by reference in its entirety. According to such an embodiment, DVR 102 includes a communications interface comprising an attachment port on the housing 219 of the DVR that cooperatively mates with the plug of external storage 220. A cable complying with the high-speed bus (i.e., a cable complying with the SATA standards) provides the transmission medium between external storage 220 and DVR 102.

According to some embodiments, the communication interface 222 is a bus complying with wired infrastructure and protocols, such as, for example, the IEEE 1394 (Firewire) standard or the Universal Serial Bus (USB) standard, among others. However, in some instances, the communication interface 222 is a wireless medium. According to one such a wireless embodiment, the external storage device 220 communicates with DVR 102 using a wireless protocol such as the IEEE 802.11 protocol, among others.

Some embodiments of DVR 102 include a communications interface comprising a slot or port for readily removable media. The readily removable media is, for example, flash memory, an HDD, optical media, or magnetic media, among others. The slot or port can be used for inserting and/or removing the device which, according to some embodiments, is physically located internal or external to the housing of the DVR. Thus, depending on a selected embodiment, readily removable media can comprise internal storage 218 or external storage 220.

User input received during the course of execution of any processes implemented by DVR 102 are received from an input device (not shown) via input system 210, transmitted through the bus 200, at least temporarily stored within memory 214, and communicated to processor 206. Data generated by an application is stored in memory 214 by processor 206 during the course of the execution of the application. Availability, location, and amount of data generated by one application for consumption by another application is communicated by messages through the services of operating system 224, among others. Hence, preferences for the operation of the DVR functions is input by, among others, a subscriber using a remote and/or remotely under the control of an entity other than the user (e.g., by a command or other configuration change transmitted from the cable head-end). Changes to decision-making logic associated with the applications described herein are made by, among others, a variety of mechanisms under software control.

A navigator application 226 provides a navigation framework for services provided by DVR 102. Navigator 218 registers for, and in some cases reserves, certain user inputs related to navigational keys such as channel increment/decrement, last channel, favorite channel, etc. Navigator 218 also provides users with television (or other programming) related menu options that correspond to DVR functions such as, for example, providing an interactive program guide, blocking a channel or a group of channels from being displayed in a channel menu, recording particular channels, playback of recorded shows, etc.

Under user instruction, DVR application 228 performs the general tasks of recording and/or playing back received media content stored as media data. Among other functions, DVR application 228 manages media data and related information. For example, according to some embodiments, DVR application 228 determines when and to which device the media data and related information will be stored to respective available storage devices. As well, as communication with storage devices is established or broken (e.g., by, among other possibilities, attaching and detaching external storage devices to the DVR), DVR application 228 performs a number of tasks to ensure that respective information associated with media data on the storage devices is managed accordingly. These aspects of DVR application 228, and others, will be described in more detail below.

Applications, such as navigator 226 and DVR application 228, among others, utilize services provided by window manager 232 and/or other graphics utilities provided by operating system 224 to draw dialog boxes, menus, graphics, etc., for display on playback device 106. Window manager 232, which in one embodiment is part of operating system 224, contains functionality for allocating screen areas and managing screen use among the various applications. Accordingly, window manager 232 provides the user interface for the DVR.

The applications executed by DVR 102 comprise executable instructions for implementing logical functions. In some instances, the applications are embodied in any computer-readable medium for use by, or in connection with, an instruction execution system. Some embodiments of the instruction execution system are, for example, a computer-based system, a processor-containing system, or any other system capable of executing or interpreting instructions. In the context of this document, a “computer-readable medium” is any means that can contain, store, communicate, propagate, or transport the program for use by or in connection with the instruction execution system, apparatus, or device.

Some embodiments of the computer-readable medium are, for example, among others, an electronic, solid-state, magnetic, optical, electromagnetic, infrared, or semiconductor system, apparatus, device, or propagation medium, either internal to DVR 102 or externally connected to the DVR 102 via one or more communication ports or network interfaces. More specific examples (a non-exhaustive list) of the computer-readable medium would include the following: an electrical connection (electronic) having one or more wires, a portable computer diskette (magnetic), a hard drive storage device (magnetic), a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

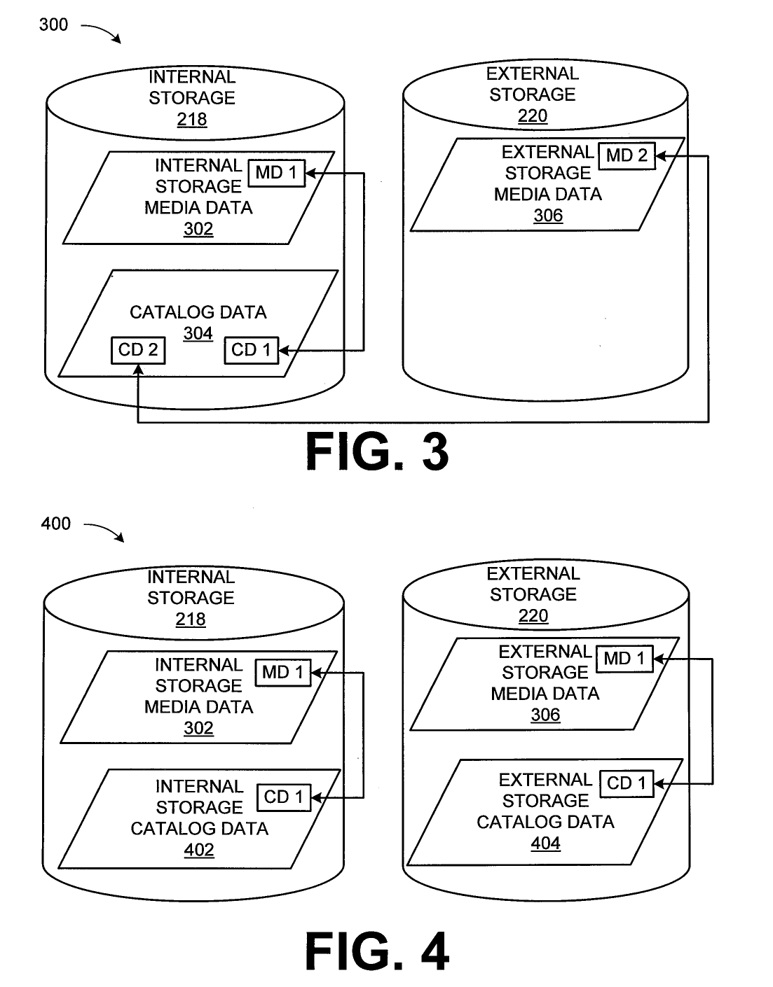

FIGS. 3 and 4 depict data storage configurations that can be used in association with the DVR 102 of FIG. 2. As will be described in more detail below, FIG. 3 depicts a configuration in which catalog data is stored on a storage device tied to the DVR, such as internal storage 218 regardless of the storage medium used to store its associated catalog data, and FIG. 4 depicts a configuration in which catalog data is co-located on a storage medium with its associated media data.

Although co-locating the catalog data with its associated media data enhances portability of media content to other DVRs, such a configuration can potentially raise a number of digital-rights-management (DRM) issues. That is, by enhancing the portability of the media content to other devices, this could create troubling issues with respect to whether other devices have the right or entitlement to play back the media content. This is one potential reason for locating the catalog data on a storage medium tied to the DVR with which it is recorded, rather than with the media data the catalog data is associated with.

Additionally, yet another motivating factor of locating catalog data on a storage medium tied to the DVR, rather than co-locating it with its associated media data, is recorded is that the DVR is able to maintain a catalog of the content stored to devices that may be removed at any particular moment. Thus, the DVR and/or user can access this information regardless of whether the media data is accessible at the time.

Accordingly, FIG. 3 depicts an embodiment of a first data storage configuration 300 that reflects one configuration used by DVR application 228 for storing media data and related information with respect to internal storage device 218 and external storage device 220. For example, embodiments of internal storage 218 are used for the storage of media data, depicted here as internal storage media data 302. Further, catalog data 304, which is related information associated with internal storage media data 302 is also stored thereto. The catalog data 304 may include information about, among others, the associated internal media data, such as guide information (i.e. title, actors, genre, program description, channel, time, etc.), recording date, the storage locations (i.e. addresses, pointers to storage locations, etc.) of the associated media data, and/or trick play information, for example. Catalog data 304, in some embodiments, includes the file deletion rules applicable to a particular instance of recorded media content, such as an indication of the number of episodes of a series to retain or an indication whether media data associated with the instance of media content can be deleted after a specified date.

Upon establishing communication with external storage 220, external storage media data 306 can be read from and stored to external storage 220. Thus, according to some embodiments, catalog data 304 associated with external storage media data 306 is stored with the catalog data 304 on internal storage 218. Accordingly, in such embodiments, internal storage device 218 is used to store catalog data associated with both internal storage media data 302 and external storage media data 306. Looking to FIG. 3, such associations are reflected in the depiction of an instance of media data MD1 (in internal storage media data 302) having an association with the catalog data labeled CD1. Similarly, an instance of media data MD2 (in the external storage media data 306) is associated with catalog data CD2.

Notably, according to such an embodiment, all of the catalog data for the respective instances of media data is located on internal storage 218. Accordingly, the catalog data pertaining to a plurality of storage devices is stored to one of the storage devices, while the media data associated with the catalog data is spread across multiple storage devices (e.g., internal storage 218 and external storage 220). Thus, according to some embodiments, the catalog data used by the DVR 102 is stored to storage devices other than the devices used to store media data to which it shares an association. Such an embodiment can be potentially attractive for its implementation simplicity. For example, the storage location of the external storage media data 306 can be viewed, from the standpoint of the various applications executed by DVR 102, as a logical extension of the storage location of media data 302 without the need for resolving additional implementation hurdles. Additionally, in some instances, the catalog data 304 is much smaller in storage requirements than its associated catalog data. Thus, with respect to storage space considerations, in such embodiments there is little reason to spread the storage of catalog data across additional storage devices to which associated media data is stored.

FIG. 4 depicts another embodiment of a data storage configuration 400 that can be used within the PVR 102 of FIG. 2. Specifically, the embodiment reflects another configuration of the storage of media data and catalog data capable of use by, for example, DVR application 228. In some cases, such an embodiment can potentially have a number of advantages over the implementation of FIG. 3.

According to such an embodiment, like configuration 300, internal storage 218 includes internal storage media data 302 and external storage 220 includes external storage media data 306. However, according to configuration 400, catalog data associated with the media data stored to each device is also stored to the respective storage device. Thus, unlike configuration 300, internal storage 218 includes internal storage catalog data 402 and external storage 220 includes external storage catalog data 404. Accordingly, an instance of media content, represented as media data MD1 (in internal storage media data 302) is associated with the catalog data labeled CD1. Similarly, an instance of media content, represented as media data MD2 (in the external storage media data 306) is associated with catalog data CD2. Notably, the catalog data is stored to the same storage device (or medium) as its associated media data. Thus, external storage catalog data 404 comprises catalog information that is associated with the external media data 306, and internal storage catalog data 302 comprises catalog information that is associated with the internal media data 402.

According to some embodiments, media data and/or catalog data is stored within a respective logical or physical partition of a respective storage medium. For example, external storage media data 402 is stored in a first partition, while external storage catalog data 404 is stored within another partition. However, in other embodiments, the media data and catalog data can be commingled within the same partition.

Thus, it should be understood that, according to some embodiments, the DVR 102 includes logic for storing media data and associated catalog data (having catalog information associated with the media data) on a storage medium of a respective storage device, such as, among others, internal storage device 218 or external storage device 220. The catalog data is associated with the media data stored to the respective device. Such a feature can be desirable in the case that one or the other of internal storage 218 or external storage 220 is removed from, or added to, the media recording device.

According to one example, external storage 220 is portable and is capable of being transported between a number of DVRs. If the external storage catalog data 404 is not stored to external storage 220, the DVR to which it is attached is not capable of obtaining the catalog information for the associated shows from the external storage device. In some embodiments, the catalog information also includes the storage locations (i.e., addresses, pointers to storage locations, etc.) of the associated media data. Thus, according to such embodiments, the digital media device may not be able to retrieve the media data (i.e., for playback) without such storage location information. However, by co-locating the catalog data with its associated media data, a digital media recorder such as DVR 102 is able to read the catalog data from the portable storage medium in order to perform various operations on the associated media data.

Although co-locating the catalog data with its associated media data on a storage medium enjoys a number of advantages, some embodiments include additional processing to use and manage the media data. That is, because the catalog data is split among multiple devices, embodiments of DVR application 228, for example, may include specialized logic for recording and retrieving media data, as well as applying media data retention rules and/or displaying user prompts related to the management of the media data and catalog data, among other logic.

For example, according to one embodiment, media data retention rules comprise logical rules for determining which of the media data stored to the HDD is to be deleted, and the rules may use the catalog data associated with the media data for accomplishing this purpose. For example, according to some embodiments, the logical rules define that media data recorded before a specified date be deleted, or that only a specified number of episodes of media programming be retained. In some instances, the associated media data that meets the rules is deleted only when space is needed (e.g., in order to record another instance of media data). It can be appreciated that these are merely examples, and a wide variety of media retention rules are possible.

In some instances, such rules are applied at a time after establishing communication with a storage medium, such as after attachment of external storage 220 or establishing a wireless connection with external storage device 220. Another time for applying the retention rules could include, but is not limited to, before recording a media instance, at the time of scheduling the recording of a media instance, or at a scheduled time, among others.

According to some embodiments, one set of logical rules are defined for use with all storage devices, i.e., irrespective of particular storage devices, while in other embodiments the logical rules are defined separately for each specified storage device. For example, a first set of retention rules can apply to external storage 220, while a second set of retention rules apply to internal storage 218. In some embodiments, the logical rules are stored on the respective storage medium with the associated media data and catalog data, for example. Such an embodiment can be advantageous to mitigate the possibility of media data being inadvertently deleted as the storage medium is moved between a number of media recording devices having conflicting retention rules.

However, some embodiments include retention rules that are applied to all, or a subset of, the storage devices associated with, or otherwise in communication with, the DVR 102. According to one non-limiting example, DVR 102 includes a retention rule for retaining only the last five recorded episodes of a particular television program. Meanwhile, external storage 220 may already include ten episodes of the television program which were, for example, recorded previously under different rules, or recorded with another DVR. After attaching external storage 220 to the DVR 102, the media retention rules are applied to the media data stored to external storage 220. According to such an embodiment, DVR 102 accesses the external storage catalog data 404 and the internal storage data 402 to identify the last five recorded episodes of the television show to retain or identify those episodes that are not the last five recorded episodes to be deleted. For example, according to such an embodiment, the retention rules retrieves information from the respective catalog data that indicates the date that an instance of media data was recorded to determine the last five recorded episodes.

It should be understood that the above embodiments are merely a subset of acceptable examples, and a wide variety of retention rules can be used. For example, some media data retention rules are applied on a program-by-program basis (record a designated program and keep for X days or until deleted by a user), a series-by-series basis (record X episodes of this television series, and delete the episode having the oldest recording date), or on a storage space-remaining basis, among others. Regardless, in such embodiments, the catalog data for the storage medium can be accessed to determine which instances of media data to retain and/or delete.

In some embodiments, before media data is deleted based on the media data retention rules, a user is prompted to ensure that media data is not unintentionally deleted. For example, according to one such embodiment, window manager 232 is used to display a GUI interface with a warning indicating that identified media data is going to be deleted (i.e., “Do you wish to delete this episode of Smallville?”). A user is able to select an option that either signals a confirmation of the deletion, or signals that the media data should not be deleted.

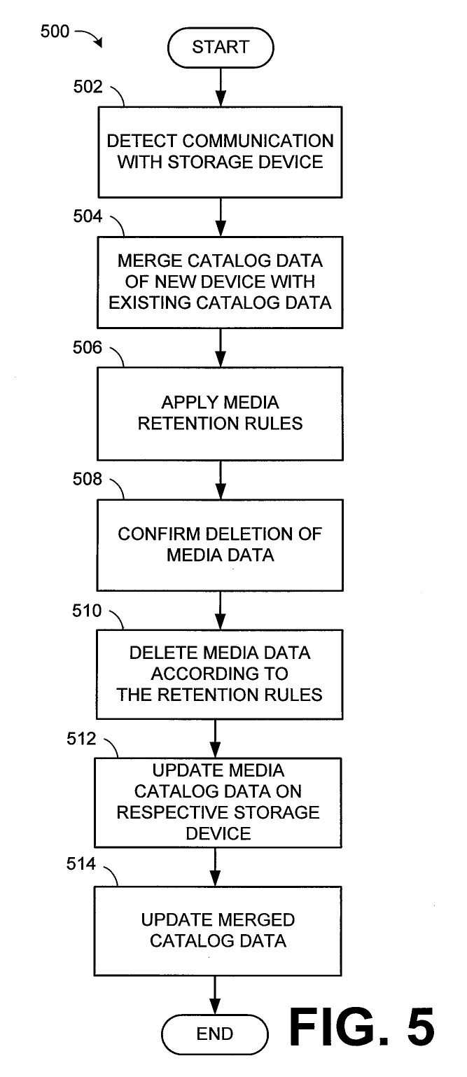

Accordingly, FIG. 5 depicts a process flow diagram of a process 500 for applying retention rules to one or more associated storage devices, such as internal storage 218 and and/or external storage 220. Some embodiments of the method can be used with storage devices having the catalog data co-located with its associated media data as discussed with respect to data storage configuration 400 of FIG. 4.

At block 502, communication with a storage device is detected. For example, depending on the particular embodiment, this detection is triggered as a result of a storage device being physically connected to the DVR to establish the communication, the storage device being placed in wireless communication with the DVR to establish the communication, among others. According to some embodiments, the establishment of communication triggers a system signal which can be used by DVR application 228 as an indication that the communication has been established with the storage device.

At block 504, in some embodiments, the catalog data stored to the storage medium of the newly detected storage device is merged with the existing catalog data. It should be understood that, depending on a selected embodiment, the merged catalog data merely references the location of the catalog data of the newly detected storage device, merges all of the catalog data of the newly detected storage, and/or merges some of the catalog data of the newly detected storage, among others.

For example, according to some embodiments, the merged data is a table or other data structure that includes references to the one or more locations of catalog data on a storage device. Hence, if an application requests the need for catalog data, the data structure can be accessed in order to determine the locations of all the associated catalog data for the respective storage devices in communication with the DVR. Each device is then accessed independently to retrieve the catalog data. For example, to search the media catalog for a particular media content instance, to apply media data retention rules, or perform other tasks using the media catalogs stored to the storage devices, the media data of each catalog is accessed sequentially or in some other order (i.e., randomly, or based on a device id, etc.).

However, unlike embodiments that provide only a logical address or other pointer to the actual media catalogs, some embodiments can merge all or some of the data in the catalog data, stored to the storage medium of the newly detected storage device, with any existing catalog data. According to such an embodiment, the merged catalog data can be stored into one or more files or other data structures for access by DVR applications. Such an embodiment can be advantageous for implementation purposes, potential increases in data access speed, etc. As an example, assuming a DVR already includes an internal storage device having media data and an associated media catalog stored thereon, the media catalog stored to a newly detected external storage device is merged with the media catalog of the internal device.

Some embodiments store the resulting merged catalog data in volatile or non-volatile memory (i.e., one or more of memory 214, internal storage 218, external storage 220, etc.) for use in performing various tasks such as, but not limited to, displaying guide information to a user, performing searches for media content, and applying retention rules. It should be understood that such a merging action could be undertaken periodically, at a time after detecting the external storage device, and/or just before performing any of these various tasks, among other appropriate times. Additionally, as media data and/or catalog data are updated the merged catalog data is also updated as needed. Similarly, upon losing communication with any of the storage devices, the merged data catalog is updated appropriately.

At block 506, media retention rules are applied to the merged catalog data. For example, the merged catalog data is accessed and programming may be flagged for deletion according to the predefined media retention rules.

As discussed previously, some embodiments may request user input to determine whether to apply the rules to particular media content to avoid inadvertent deletion of media data. Accordingly, at block 508, a confirmation of the deletion of media data flagged for deletion is displayed to a user.

According to some embodiments, such a user confirmation embodiment is user configurable. That is, a user is given a choice to select whether a user confirmation interface is to be used to delete flagged media content after a new storage device is detected.

At block 510 the flagged, and potentially confirmed, media data is deleted from the appropriate storage device. For example, media data stored on one or both of internal storage device 218 or external storage device 220 is deleted.

At block 512 catalog data on the respective storage device is updated. For example, the catalog data associated with the deleted media data can be removed from the respective storage device.

At block 514, according to some embodiments, the merged catalog data is updated to reflect any changes made to the catalog data on the respective device. According to some embodiments, this updating block is not needed in the case that the merged catalog data does not include updated information. For example, if the merged catalog data merely comprises a location of where catalog data is stored for a particular device, updating is not needed. However, where the merged catalog data includes information such as the title of recorded media content, actors associated with media content, or the date media content is recorded, among others, the merged catalog data is updated to reflect that any associated media data has been deleted. For example, the catalog data associated with the deleted content may be removed from the merged catalog data.

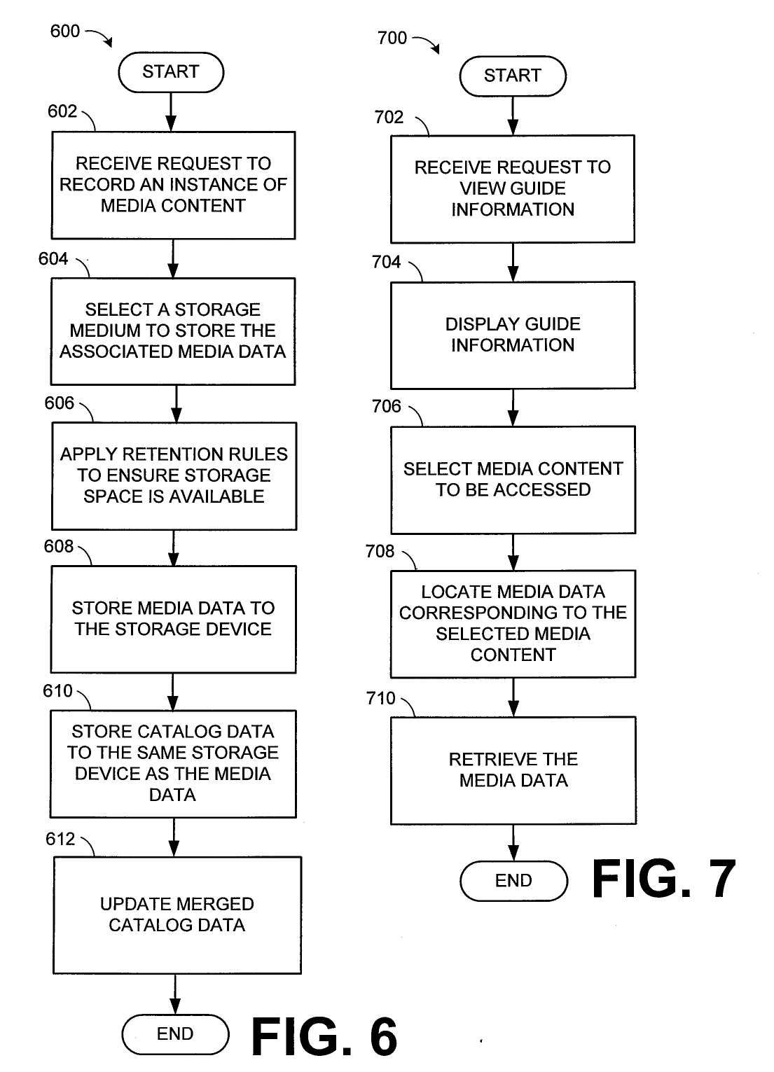

FIG. 6 is a process flow diagram of an exemplary process 600 used for recording an instance of media data to one or more associated storage devices, such as to internal storage 218 and and/or external storage 220. At block 602 a request to record an instance of media content is received. For example, in some instances, the request is generated from a scheduler application that is configured to record programs at previously scheduled times. However, in some instances, the request is generated at the request of a user. For example, in some instances, a user is able to indicate that a program appearing on a selected channel is to be recorded by pressing a record button on a remote control device that is configured to emit signals to the DVR.

At block 604 a storage medium to which to record media data associated with the requested media content is selected.

At block 606, in some instances, retention rules are applied to make space for recording the media data to the selected storage device. For example, the space needed to record a particular instance of media data is determined. In some embodiments, such a determination can be an estimate based on, among others, the length of the program and/or a recording quality to be used (e.g., defining a resolution, bit rate, and/or frame rate, among other factors). Once determined, if necessary, the retention rules can be used to determine which, if any, previously recorded media data can be deleted to ensure that enough storage space is available for recording the requested instance of media content. In some instances, the rules, or other logic, may specify that one of the storage devices be filled first (i.e., record media data to external storage 220 before recording media data to the internal storage 218) or that the storage devices be filled based on a load balancing policy.

At block 608, media data corresponding to the instance of media content is stored to the storage medium of the selected media device. At block 610, catalog data associated with the media data is also stored to the selected media device. At block 612, if necessary, merged catalog data can be updated to reflect the newly recorded instance of media data. For example, in some embodiments, related information (i.e., title, etc.) is added to the merged catalog data.

FIG. 7 is a process flow diagram depicting an exemplary process 700 for retrieving an instance of media data from one or more associated storage devices, such as internal storage 218 and and/or external storage 220. Such a retrieval process could be used for playback of media content stored to one of internal storage 218 and and/or external storage 220, for example. At block 702, a request is received to view guide information. For example, in some instances, the request is initiated by a user (e.g., by pressing an associated button on a remote control device that is configured to emit signals to the DVR). At block 704, the requested guide information is displayed. For example, the guide information can be retrieved from the catalog data and/or merged catalog data, formatted, and displayed on television 106 by window manager 232.

At block 706, media content to be accessed (e.g., for playback, among other possible purposes) can be selected from the guide information. For example, in some instances, a user selects desired media content based on the displayed guide information.

At block 708 the location of the media data corresponding to the selected media content is located. For example, according to some embodiments, the location is defined in the catalog data for the respective storage device and/or the merged catalog data. The location may correspond to a logical address or a storage device id, among other possible media data location identifiers. It can be appreciated that, in some embodiments, media data can be stored in one or more files that comprise a number of logically linked data clusters or other allocation units. The one or more files can be stored in one or more directories. The one or more directories can comprise one or more logical lines to associated files and/or other directories. In some embodiments a root directory resides on a storage device tied to the DVR, such as internal storage 218, which can reference directory structures located on internal storage 218 as well as external storage 220. Thus, media data on any storage device can be located by traversing these linked file structures, among many other conventional methods. At block 710 the media data can be retrieved based on the location identifier.

FIG. 8 is a process flow diagram depicting an exemplary process 800 for applying retention rules to one or more associated storage devices, such as internal storage 218 and and/or external storage 220, at a time after losing communication with an associated storage device. At block 802, the loss of communication with a storage device is detected. For example, an external storage device 220 may be unplugged from DVR 102 or lose a wireless connection with DVR 102, among other possibilities. At block 804, in some embodiments, the merged data catalog may be updated to reflect a current inventory of catalog data associated with the media data of the remaining storage devices. It can be appreciated that this may be accomplished by rebuilding the merged catalog data with the catalog data stored to the remaining storage devices, by removing the catalog data associated with the removed/non-communicating device from the merged catalog data, removing a pointer to the removed/non-communicating device from the merged catalog data, among other possibilities.

Any process descriptions, steps, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, including substantially concurrently or in reverse order, depending on the functionality involved, as would be understood by those reasonably skilled in the art.

Conditional language, such as, among others, “can,” “could,” “might,” or “may,” unless specifically stated otherwise, or otherwise understood within the context as used, is generally intended to convey that certain embodiments, among others, include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A system comprising:
a digital media device comprising memory, processing logic, and a communications interface configured to transport data between an external storage device and the digital media device, the external storage device configured to store media data recorded by the digital media device and maintain a media catalog associated with the media data stored to the external storage device.

2. The system of claim 1, wherein the digital media device further comprises:
an internal storage device configured to store media data recorded by the digital media device and maintain a media catalog associated with the media data stored to the internal storage device.

3. The system of claim 2, wherein the digital media device further comprises:
processing logic configured to merge the media catalog stored to each of the internal and external storage devices into a merged media catalog.

4. The system of claim 3, wherein the processing logic configured to merge the media catalog is further configured to merge the media catalog stored to each of the internal and external storage devices at a time after the digital media device establishes communication with the external storage device.

5. The system of claim 3, wherein the merged media catalog comprises a reference to a location of the media catalog stored to the external storage device.

6. The system of 3, further comprising:
processing logic configured to update the merged media catalog at a time after the external storage device loses communication with the digital media device.

7. The system of claim 6, wherein the external storage device is removably detachable from the digital media device, and the digital media device further includes:
processing logic configured to update the merged media catalog at a time after the external storage device is disconnected from the digital media device.

8. The system of claim 7, wherein the digital media device further comprises:
processing logic configured to apply rule-based deletions to the media data stored to at least one of the internal storage device or the external storage device in response to establishing communication with the external storage device.

9. The system of claim 1, wherein the external storage device includes a media catalog storage partition and the media catalog is stored in the media catalog storage partition.

10. A method for managing media data comprising:
storing respective media data to each of an internal storage device and an external storage device of a digital media recording device; and
maintaining a media catalog, associated with the respective media data, stored on the respective storage devices.

11. The method of claim 10, further comprising:
merging the media catalog stored to each of the internal and external storage devices into a merged media catalog.

12. The method of claim 11, wherein the step of merging the media catalog further comprises merging the media catalog stored to each of the internal and external storage devices at a time after the digital media device establishes communication with the external storage device.

13. The method of claim 12, further comprising:
updating the merged media catalog at a time after the external storage device loses communication with the digital media recording device.

14. The method of claim 13, wherein updating the merged media catalog further comprises:
updating the merged media catalog at a time after the external storage device is disconnected from the digital media recording device.

15. The method of claim 12, further comprising:
applying rule-based deletions to the media data stored to at least one of the internal storage device or the external storage device in response to establishing communication with the external storage device.

16. A system comprising:
first storage means associated with a digital media device; and
second storage means detachably attached to the digital media device, the first and second storage means for storing media data recorded by the digital media device and maintaining a media catalog associated with the media data stored on the respective storage device.

17. The system of claim 16, farther comprising:
means for applying rule-based deletions to the media data stored to at least one of the internal storage device or the external storage device in response to establishing communication with the external storage device.

18. The system of claim 16, further comprising:
means for updating a merged media catalog at a time after the external storage device is disconnected from the digital media recording device.

19. The system of claim 16, further comprising:
means for updating a merged media catalog at a time after the external storage device is connected to the digital media recording device.
